(19) United States
(12) Patent Application Publication
(10) Pub. No.: US 2025/0057103 A1
(43) Pub. Date: Feb. 20, 2025

(54) MILKING INSTALLATION

(71) Applicant: DELAVAL HOLDING AB, Tumba (SE)

(72) Inventors: Han EIJKELKAMP, Tumba (SE); Robert JENSEN, Tumba (SE); Thomas JOHANSSON, Tumba (SE); Peter KRAGT, Tumba (SE); Andrés LUNDH, Tumba (SE); Martin SJÖLUND, Tumba (SE); Jouko TIAINEN, Tumba (SE); Johan Ter WEELE, Tumba (SE)

(21) Appl. No.: 18/720,319

(22) PCT Filed: Dec. 16, 2022
(86) PCT No.: PCT/SE2022/051195

§ 371 Date: Jun. 14, 2024

(30) Foreign Application Priority Data
Dec. 17, 2021 (SE) 2151553-1

(51) Int. Cl. A01J 5/007; A01J 9/04

(52) U.S. Cl. CPC A01J 5/007; A01J 9/04

(57) ABSTRACT

The disclosure concerns a milking installation including milking positions configured to milk one animal at a time, a first common milk line connected to a first milk receiver, a second common milk line connected to a second milk receiver, a control arrangement, and at least one robot arm. Each milking position includes at least one teat cup and a flow directing arrangement, the flow directing arrangement including an inlet arrangement connected to the teat cup, a first outlet arrangement connected to the first milk line, and a second outlet arrangement connected to the second milk line. The control arrangement is configured to control the flow directing arrangement to fluidly connect the teat cup via the inlet arrangement with either the first outlet arrangement or the second outlet arrangement.

### TECHNICAL FIELD

The invention relates to a milking installation configured to milk animals.

### BACKGROUND

Animals, such as cows, may be milked in a milking installation comprising several milking positions for individual milking of an animal. At each milking position there is provided milking equipment for drawing milk from the teats of an animal. Typically, the animals are admitted to the milking installation in groups. The milking positions may be stationary or may be provided on a platform which is rotated such that animals can enter respective milking positions at an entrance location and be milked whilst being conveyed around on the platform to an exit location where the milked animals can leave the platform.

Also known is a milking installation including at least one automatic milking system, AMS, i.e., a system wherein animals are milked fully automatically without any direct human supervision of the milking process. Animals can on a voluntary basis enter a milking position of the AMS, have teat cups automatically attached to their teats e.g., by a robot arm, and be milked. Feedstuff may be supplied to the animal in the AMS e.g., to lure the animal into the AMS and the milking position. An AMS may provide an efficient manner of milking a suitably sized group of animals.

Further, milking installations configured to milk groups of animals in an automated manner are known e.g., from WO 2008/003341 and EP 3214923.

WO 2008/003341 discloses a milking installation that includes a rotary platform for transporting animals to fully automated milking stalls. The animals are allowed to board the rotating platform at a loading zone and to disembark the platform at an available milking stall under the control of gates located around the platform.

EP 3214923 discloses a device for automatically milking fluid from udders of animals of a herd of cows in a time-specifiable manner. The device contains a plurality of milking robots arranged on a base for automatically milking animals, wherein each milking robot has an inlet and an outlet and a milking cluster that can be automatically attached to the udder of an animal. The device further comprises a fenced waiting area located upstream of the inlets of the milking robots for the animals of a herd to be milked. The waiting area has an entrance for manually delivering the animals to the waiting area. The device has an animal driver unit for automatically herding animals located in the waiting area to the inlets of respective milking robots that are becoming available.

### SUMMARY

In automated milking of animals, an intention is to keep human intervention at a minimum. It still has to be ensured that milk not suited for human consumption i.e., milk from certain animal individuals, can be diverted from milk intended for human consumption.

Automated milking of animals in groups does not exclude that milk from certain animal individuals within a group has to be handled differently than the milk from a majority of the animals within the group.

Accordingly, it is an object of the invention to provide a milking installation configured to automatically milk all animals within a group of animals while ensuring that milk from certain animal individuals within the group is handled differently than the milk of the remaining animals within the group.

To address this object, a milking installation having the features defined in the independent claim is provided.

According to an aspect of the invention, the object is achieved by a milking installation configured to milk animals, the milking installation comprising a number of milking positions configured to milk one animal at a time, a first common milk line, a first milk receiver, a second common milk line, a second milk receiver, a vacuum system, a control arrangement, and at least one robot arm. Each milking position of the number of milking positions comprises at least one teat cup and a flow directing arrangement, the flow directing arrangement comprising an inlet arrangement, a first outlet arrangement, and a second outlet arrangement. The at least one teat cup is connected to the inlet arrangement, the first outlet arrangement is connected to the first common milk line, and the second outlet arrangement is connected to the second common milk line. The control arrangement is configured to control the flow directing arrangement at each milking position to fluidly connect the at least one teat cup via the inlet arrangement with either the first outlet arrangement or the second outlet arrangement. The first common milk line is connected to the first milk receiver and the second common milk line is connected to the second milk receiver. The vacuum system is connected to the first milk receiver and to the second milk receiver. The at least one robot arm is configured to attach the at least one teat cup of at least one milking position to a teat of an animal.

Since the first outlet arrangement is connected to the first common milk line and the second outlet arrangement is connected to the second common milk line, since the first common milk line is connected to the first milk receiver and the second common milk line is connected to the second milk receiver, and since the control arrangement is configured to control the flow directing arrangement at each milking position to fluidly connect the at least one teat cup via the inlet arrangement with either the first outlet arrangement or the second outlet arrangement—milk from animals milked in each of the milking positions of the number of milking positions can be directed either to the first milk receiver or to the second milk receiver. Moreover, since the at least one robot arm is configured to attach the at least one teat cup of at least one milking position to a teat of an animal, the directing of the milk to either to the first milk receiver or to the second milk receiver is achieved in a milking installation configured for automated milking of animals. Accordingly, the automated milking installation is configured to direct milk suited for consumption to the first milk receiver and other milk to the second milk receiver.

As a result, the milking installation is configured to milk all animals of a group of animals irrespective of whether the milk from an animal individual is suitable for consumption or not. Accordingly, the above-mentioned object is achieved.

The milking installation may be a milking installation arranged in a farm building or underneath a protective roofing structure e.g., in connection with a pasture area.

The milking installation is configured to milk a group of animals since it comprises a number of milking positions. In this context a group of animals may be formed by animals living together as a constellation over a longer period of time. A farm may keep its animals in a number of such groups. Each group is kept together and handled as one entity e.g., during feeding, milking, etc. Changes may be made in the constellation of the group by adding and/or subtracting one or a few animal individuals.

The animals are milk producing animals such as cows, sheep, or goats. The milking positions are configured to milk the particular kind of animal. For instance, each milking position comprises a relevant number of teat cups for the particular kind of animal.

The milking installation may comprise further milk receivers. For instance, further milk receivers may be provided for differentiating between different kinds of milk not suited for human consumption, such as colostrum and milk from animals being medically treated. The further milk receivers may be connected to the second common milk line or to separate milk lines connectable via the flow directing arrangements at the milking positions to the teat cups of the milking positions. The vacuum system may be connected to such further milk receivers.

Each milking position of the number of milking positions is configured to milk one animal at a time and comprises for this purpose the at least one teat cup and the flow directing arrangement. From each milking position, utilising the respective flow directing arrangement, the at least one teat cup is fluidly connectable either with the first common milk line and the first milk receiver or with the second common milk line and the second milk receiver of the milking installation.

The vacuum created by the vacuum system provides the milking vacuum utilised in the at least one teat cup of each milking position for milking of animals.

As mentioned above, the vacuum system is connected to the first milk receiver and to the second milk receiver. Accordingly, it is ensured that the at least one teat cup at each milking position is provided with a milking vacuum, irrespective of whether the at least one teat cup is connected to the first milk receiver or the second milk receiver.

The milk in the first milk receiver may be further transported to a storage for milk intended for consumption or for further processing with the aim of being consumed, hereinafter referred to as milk for consumption. Commonly, this forms the main part of all milk from a group of animals.

The milk in the second milk receiver may be further transported to a separate milk storage or may be disposed of. These may be options if the milk is not suited for consumption.

The flow directing arrangement may be a valve manifold capable to direct milk from an udder portion of an animal to one out of several containers, such as the first and second milk receivers.

According to embodiments, each milking position may comprise several teat cups and each teat cup may be connected to the inlet arrangement of the flow directing arrangement via a respective milk conduit. In this manner, udder portions of an animal may be milked independently of each other.

Moreover, the first outlet arrangement may comprise one conduit connected to the first common milk line for each teat cup and the second outlet arrangement may comprise one conduit connected to the second common milk line for each teat cup. In this manner, milk from each udder portion may be directed either to the first milk receiver or to the second milk receiver.

If the animals to be milked in the milking installation are cows, each milking position comprises four teat cups. In this case, the udder portions to be milked are udder quarters. If the animals to be milked in the milking installation are sheep or goats, each milking position comprises two teat cups. In this case, the udder portions to be milked are udder halves.

According to embodiments, each milking position may be configured to, during milking of one animal individual, conduct milk from the one animal individual via the flow directing arrangement, to the first milk receiver or to the second milk receiver. In this manner, milk milked from animals at each milking position may be directed to the first milk receiver or the second milk receiver without temporarily storing milk at the milking positions.

Thus, a cost-efficient milking installation may be provided by being able to eliminate a local milk receiver at each milking position, while still being able to extract milk for consumption which is conducted to the first milk receiver and milk not suited for consumption which is direct to the second milk receiver.

According to embodiments, each milking position may comprise a milk sensor arrangement fluidly connected to the at least one teat cup. The control arrangement may be configured to control the flow directing arrangement to fluidly connect the at least one teat cup via the inlet arrangement with either the first outlet arrangement or the second outlet arrangement based on animal individual milk parameters sensed by the milk sensor arrangement. In this manner, data provided by sensors of the milk sensor arrangement may be provided for directing milk of different qualities to different milk receivers.

The milk sensor arrangement may suitably be arranged in, or connected to, a flow path between the at least one teat cup and the flow directing arrangement.

The milk sensor arrangement may comprise at least one milk quality sensor for each teat cup at each milking position.

The sensor arrangement may comprise one or more of a milk conductivity sensor, a milk colour sensor, a milk temperature sensor, and other type of milk quality sensor. Thus, the milk parameters sensed by the milk sensor arrangement may be one or more of e.g. conductivity, colour, and temperature. Accordingly, a quality of milk extracted from an animal may be determined and utilised by the control arrangement for controlling the flow directing arrangement to connect the at least one teat cup via the inlet arrangement with either the first outlet arrangement or the second outlet arrangement.

According to embodiments, each milking position may comprise an animal identification device. The control arrangement may be configured to control the flow directing arrangement to fluidly connect the at least one teat cup via the inlet arrangement with either the first outlet arrangement or the second outlet arrangement based on animal identity provided by the animal identification device. In this manner, the identities of animals in the milking positions may be established in order to direct extracted milk of different qualities from different animal individuals to different milk receivers.

Namely, a database of the animal individuals to be milked in the milking installation may contain updated milk data for each animal individual. Accordingly, for each animal individual there may be provided data related to whether its milk is to be directed to the first milk receiver or the second milk receiver i.e., whether the animal individual milks milk for consumption or not.

The control arrangement may comprise the animal identification devices.

According to embodiments, the milking installation may comprise a holding area configured to temporarily house a group of animals prior to being milked, wherein each milking position of the number of milking positions is arranged with direct access from the holding area. In this manner, a group of animals to be milked in the milking installation may be directed to, and held in, the holding area while the animals enter the milking positions.

Since the holding area is configured to temporarily house a group of animals prior to being milked, the holding area does not include any animal feeding facility or any resting stalls.

The holding area is an area wherefrom the animals of a group of animals is intended to enter the milking positions. The only way for the animals within the holding area to leave the holding area may be via the milking positions.

Each animal of the group of animals may enter the milking positions voluntarily from the holding area.

The holding area may be an enclosed area with a dedicated entrance e.g., in the form of one or more gates or one-way gates. During transfer of a group of animals into the holding area, two or more animals may enter the holding area simultaneously.

An animal leaving a milking position can only do so in a direction away from the holding area.

Accordingly, it is not possible for an animal in a milking position to therefrom re-enter the holding area.

As mentioned above, each milking position is arranged with direct access from the holding area. Herein, the term “direct access” means that an animal leaving the holding area will be able to enter an unoccupied milking position without deviation or interruption. That is, the animal leaving the holding area will either immediately set foot in the unoccupied milking position or an unobstructed passageway will lead the animal to the unoccupied milking position. Such an unobstructed passageway only leads to one milking position of the number of milking positions.

The milking positions of the number of milking positions may be arranged along one or more sides of the holding area.

According to embodiments, the holding area may be configured for the group of animals to move freely therein. In this manner, the individual animals within the group of animals may move freely within the holding area e.g., in order to enter milking positions as they become available at different portions of the holding area and/or for animals within the group to avoid one another. The latter may be the case for low ranked animals within the group of animals. Namely, within a group of animals such as cows, a strict hierarchy exists.

It may also be noted that the free movement of the animals within the holding area in combination with each milking position being arranged with direct access from the holding area entails that lower ranked animals within the group have a fair chance of finding an available milking position without being hindered by higher ranked animals of the group.

Further features of, and advantages with, the invention will become apparent when studying the appended claims and the following detailed description.

### BRIEF DESCRIPTION OF THE DRAWINGS

Various aspects and/or embodiments of the invention, including its particular features and advantages, will be readily understood from the example embodiments discussed in the following detailed description and the accompanying drawings, in which:

FIG. 1 schematically illustrates a top view of a milking installation according to embodiments,

FIG. 2a schematically illustrates a milking installation according to embodiments,

FIG. 2b shows a flow directing arrangement, and

FIG. 3 illustrates a control arrangement for controlling a milking installation.

### DETAILED DESCRIPTION

Aspects and/or embodiments of the invention will now be described more fully. Like numbers refer to like elements throughout. Well-known functions or constructions will not necessarily be described in detail for brevity and/or clarity.

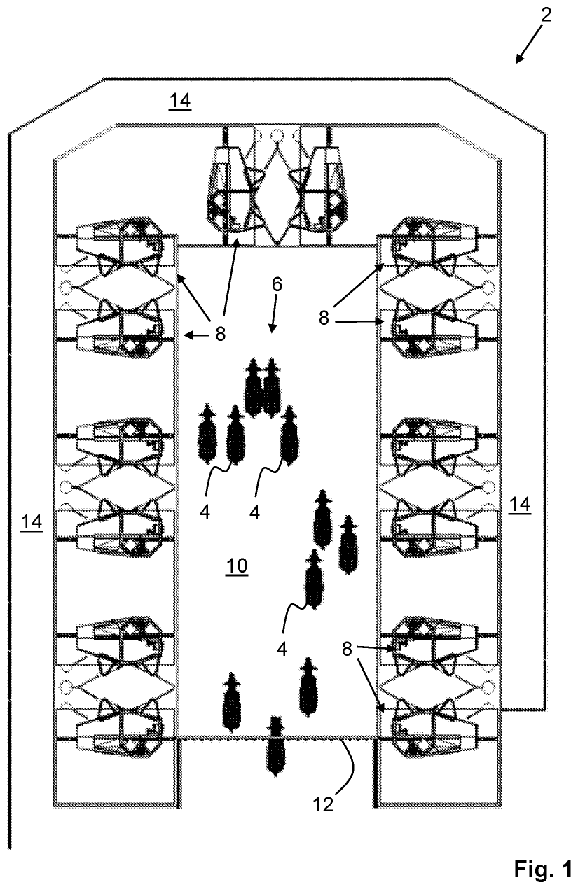

FIG. 1 schematically illustrates a top view of a milking installation 2 according to embodiments.

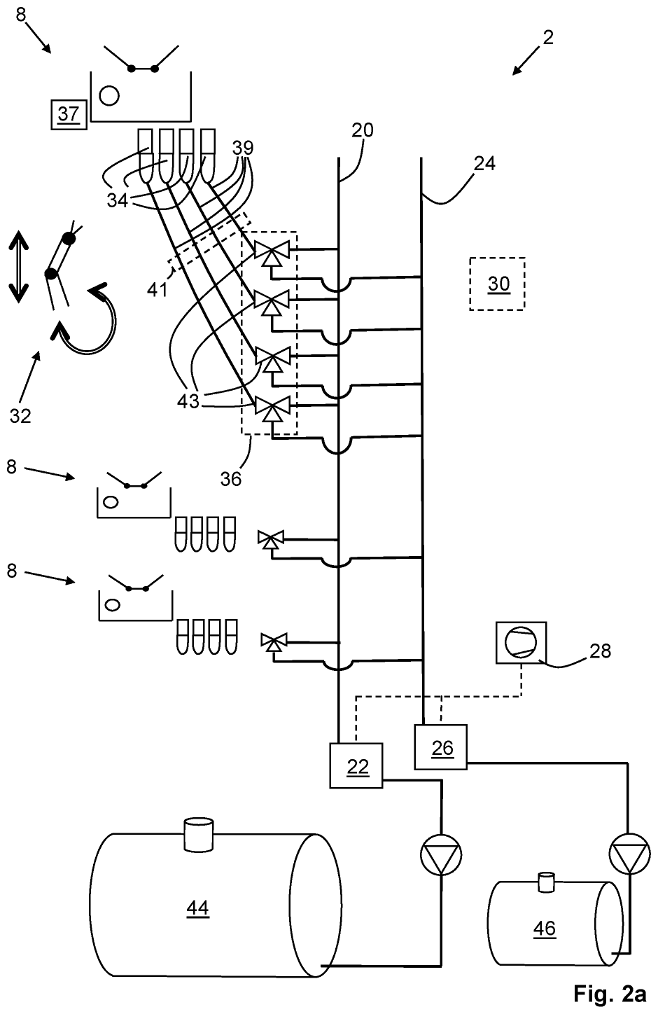

The milking installation 2 is configured to milk animals 4. For this purpose, the milking installation 2 comprises a number of milking positions 8 configured to milk one animal 4 at a time. Below, with reference to FIGS. 2a and 2b, milking equipment of the milking installation 2 is discussed in further detail.

The animals 4 may be handled as a group 6 of animals. For instance, the entire group 6 is directed to the milking installation 2 for the animals 4 of the group 6 to be milked at the milking positions 8. This is also referred to as batchwise milking of animals 4.

The group 6 of animals 4 is handled as one entity and as such, besides being presented for milking in the milking installation 2 e.g., is kept in its particular stall area between milkings.

In the illustrated embodiments the number of milking positions 8 is 14 but any suitable number of milking positions 8 may alternatively be provided, such as 4 milking positions. The number of milking positions 8 may be determined e.g., by one or more of the number of animals per group, the number of groups to be milked in the milking installation 2, a desired throughput of animals in the milking installation 2, available space at a farm facility, etc. Theoretically, the higher the number of milking positions 8, the higher the milking capacity of the milking installation 2.

The number of animals in a group is larger than the number of milking positions 8.

The milking installation 2 comprises a holding area 10 configured to temporarily house a group 6 of animals 4 prior to being milked. Each milking position 8 of the number of milking positions 8 is arranged with direct access from the holding area i.e., an animal 4, when leaving the holding area 10, will immediately access one of the milking positions 8, if it is unoccupied.

The milking positions 8 adjoin the holding area 10 for the individual animals 4 in the group 6 of animals 4 to access the milking positions 8. For instance, the milking positions 8 may be arranged along one or more sides of the holding area 10.

From the holding area 10, the animals 4 of the group 6 enter the milking positions 8 as they are, or become, available.

The holding area 10 is configured for the group 6 of animals 4 to move freely therein. Thus, low ranked animals 4 within the group 6 stand a fair chance of finding an available milking position 8 without being hindered by higher ranked animals 4.

The holding area 10 may be an enclosed area with a dedicated entrance.

For instance, the milking installation 2 may further comprise a one-way gate system 12. The one-way gate system 12 may form an entrance to the holding area 10. The one-way gate system 12 may be configured for passage of animals 4 into the holding area 10.

As any one-way gate system, the one-way gate system 12 allows passage of the one-way gate system 12 in one direction and prevents passage of the one-way gate system 12 in an opposite direction.

The one-way gate system 12 may be configured for simultaneous passage of two or more animals 4 into the holding area 10.

The individual animals 4 in the group 6 of animals 4 that have entered one of the milking positions 8 cannot return from the milking position 8 into the holding area 10. Instead, an animal 4 within one of the milking positions 8 has to leave the milking position 8 via an exit of the relevant milking position 8.

A number of groups 6 of animals 4 may be kept on a farm, each group having its dedicated stall area wherein the animals 4 may rest and/or may be fed.

Each group 6 of animals 4 may be manually and/or automatically driven or directed via one or more passageways from its dedicated stall area to the holding area 10.

The milking installation 2 may comprise an exit passage 14, which is connected to each milking position 8 of the number of milking positions 8. The exit passage 14 allows the individual animals 4 in the group 6 of animals to leave the milking positions 8 after having been milked without re-entering the holding area 10.

This means that, an entry side of each milking position 8 faces the holding area 10 and an exit side of each milking position 8 faces the exit passage 14.

The exit passage 14 may lead back to the stall areas for the groups 6 of animals 4. Each group 6 of animals 4 may be manually and/or automatically driven or directed back to its dedicated stall area from the holding area 10 via the exit passage 14.

FIG. 2a schematically illustrates a milking installation 2 according to embodiments. The milking installation 2 may be a milking installation 2 as discussed above with reference to FIG. 1. In the following inter alia milking equipment of the milking installation 2 will be discussed.

As mentioned above, the milking installation 2 comprises a number of milking positions 8 configured to milk one animal at a time. In FIG. 2a, one milking position 8 is shown in more detail and further milking positions 8 are only schematically indicated.

The milking installation 2 further comprises a first common milk line 20, a first milk receiver 22, a second common milk line 24, a second milk receiver 26, a vacuum system 28, a control arrangement 30, and at least one robot arm 32.

The first common milk line 20 is connected to the first milk receiver 22 and the second common milk line 24 is connected to the second milk receiver 26. The vacuum system 28 is connected to the first milk receiver 22 and to the second milk receiver 26.

Each milking position 8 of the number of milking positions 8 comprises at least one teat cup 34.

In the illustrated embodiments, each milking position 8 comprises four teat cups 34 and accordingly, may be configured to milk cows.

Each milking position 8 further comprises a flow directing arrangement 36, indicated with a broken line box in FIG. 2a. The flow directing arrangement 36 is also shown in FIG. 2b.

In the following reference is made to FIGS. 2a and 2b. The flow directing arrangement 36 comprises an inlet arrangement 38, a first outlet arrangement 40, and a second outlet arrangement 42. The inlet arrangement 38 and the first outlet arrangement 40 are indicated with respective broken line boxes in FIG. 2b. The at least one teat cup 34 is connected to the inlet arrangement 38, the first outlet arrangement 40 is connected to the first common milk line 20, and the second outlet arrangement 42 is connected to the second common milk line 24.

As mentioned above, each milking position 8 comprises several teat cups 34, such as the exemplified four teat cups 34. Each teat cup 34 is connected to the inlet arrangement 38 of the flow directing arrangement 36 via a respective milk conduit 39.

The flow directing arrangement 36 comprises a valve manifold capable to direct milk extracted in the teat cups 34 to one out of several outlets, such as the first and second outlet arrangements 40, 42.

The valve manifold of flow directing arrangement 36 comprises a number of valves 43 corresponding to the number of teat cups 34 of a milking position i.e., four valves 43 in the illustrated embodiments.

The control arrangement 30 is configured to control the flow directing arrangement 36 at each milking position 8 to fluidly connect the at least one teat cup 34 via the inlet arrangement 38 with either the first outlet arrangement 40 or the second outlet arrangement 42.

For instance, the control arrangement 30 is configured to control each valve 43 of the valve manifold of the flow directing arrangement 36 to connect for each valve 43 an inlet 45 with one of a first outlet 47 and a second outlet 49.

As indicated for the uppermost valve 43 in FIG. 2b, the inlet 45 of each valve 43 forms part of the inlet arrangement 38, the first outlet 47 of each valve 43 forms part of the first outlet arrangement 40, and the second outlet 49 of each valve 43 forms part of the second outlet arrangement 42.

Accordingly, from each milking position 8, milk extracted from an animal is directed from the teat cups 34 either to the first milk receiver 22 via the inlet arrangement 38, the first outlet arrangement 40, and the first common milk line 20 or to the second milk receiver 26 via the inlet arrangement 38, the second outlet arrangement 42, and the second common milk line 24.

Each milking position 8 is configured, during milking of one animal individual therein, to conduct milk from the one animal individual via the flow directing arrangement 36, to the first milk receiver 22 or to the second milk receiver 26.

Thus, during milking of the animals, milk is directly conducted to one of the first and second milk receivers 22, 26 i.e., without temporarily storing milk at the milking positions 8.

In order for the control arrangement 36 to establish whether the milk from a specific animal 25 individual is to be directed to the first milk receiver 22 or the second milk receiver 26, each milking position 8 may comprise a milk sensor arrangement 41 fluidly connected to the at least one teat cup 34.

Thus, the control of the flow directing arrangement 36 may be based at least in part on data 30 provided by the milk sensor arrangement 41.

For instance, the milk sensor arrangement 41 may be arranged in one or more of the milk conduits 39 or in fluid communication therewith.

The milk sensor arrangement 41 may comprise at least one sensor for each teat cup 34. The at least one sensor is configured for sensing a milk parameter, such as a milk quality parameter. For instance, the at least one sensor may be a conductivity sensor, a colour sensor, a temperature sensor, etc.

The sensor arrangement 41 is not limited to sensing any particular kind of milk quality parameter, as long as it can be determined by the milk quality parameter/s whether the milk from an animal and/or the milk from a teat of an animal is suited for consumption or not.

Thus, milk suited for consumption can be directed to the first outlet arrangement 40 and milk not suited for consumption can be directed to the second outlet arrangement 42.

As such, different kinds of sensors for sensing milk parameters are known and do not require any further discussion.

The milk sensor arrangement 41 may form part of the control arrangement 30.

The control of the flow directing arrangement 36 may be based at least in part on animal identity and stored animal individual milk quality data.

Thus, each milking position 8 comprises an animal identification device 37 and the control arrangement 30 is configured to control the flow directing arrangement 36 to fluidly connect the at least one teat cup 34 via the inlet arrangement 38 with either the first outlet arrangement 40 or the second outlet arrangement 42 based on animal identity provided by the animal identification device 37.

The animal identification device 37 may form part of the control arrangement 30.

The vacuum system 28 produces a milking vacuum utilised in the teat cups 34 to milk animals at the milking positions 8.

The vacuum system 28 may comprise one or more vacuum pumps collectively connected to the first and second milk receivers 22, 26, as shown in FIG. 2a. Alternatively, the vacuum system 28 may comprise two or more vacuum pumps, which individually are connected to one each of the first and second milk receiver 22, 26.

More specifically, since the vacuum system 28 is connected to the first milk receiver 22 which is connectable via the first common milk line 20 and the flow directing arrangement 36 to the teat cups 34, the milking vacuum is provided at the teat cups 34 when milk is directed to the first milk receiver 22. Similarly, since the vacuum system 28 also is connected to the second milk receiver 26 which is connectable via the second common milk line 24 and the flow directing arrangement 36 to the teat cups 34, the milking vacuum is provided at the teat cups 34 when milk is directed to the second milk receiver 26.

From the individual milking positions 8, in the respective first and second common milk lines 20, 24, the milk is transported towards the first and second milk receivers 22, 26 by means of gravity. The first and second common milk lines 20, 24 are often arranged with an inclination towards the respective first and second milk receivers 22, 26 in the milking installation 2.

Moreover, the flow directing arrangement 36 may be controlled by the control arrangement 30 to close any connection between the teat cups 34 and the first and second common milk lines 20, 24. Accordingly, the flow directing arrangement 36 is operable as a shut off valve. That is, the control arrangement 30 controls the flow directing arrangement 36 to provide an open connection between the teat cups 34 and one of the first and second common milk lines 20, 24 in connection with milking of an animal in a relevant milking position 8 and to provide closed connections to both the first and second common milk lines 20, 24 in between milkings of animals. Thus, air does not leak into any of the first and second common milk lines 20, 24 when the teat cups 34 are not attached to the teats of an animal.

For instance, milk for consumption is directed from the teat cups 34 to the first milk receiver 22 and milk not suited for consumption is directed to the second milk receiver 26.

According to embodiments, the milking installation 2 may comprise a milk cooling tank 44, and the first milk receiver 22 may be fluidly connected to the milk cooling tank 44. In this manner, the milk in the first milk receiver 22 may be conducted, such as pumped, for cooling and storage to the milk cooling tank 44.

The milk cooling tank 44 may be configured to store the milk at a suitable temperature, such as 4 degrees Celsius, up to a number of days before the milk is collected and brought to a dairy.

The milk cooling tank 44 as such, may be transportable to a dairy, and accordingly may be replaced when it has been filled with an empty milk cooling tank 44.

According to embodiments, the milking installation 2 may comprise a storage container 46 and the second milk receiver 26 may be connected to the storage container 46. In this manner, the milk in the second milk receiver 26 may be conducted, such as pumped, for storage and cooling to the storage container 46.

If the milk in the second milk receiver 26 is milk not suited for human consumption, the milk in the storage container 46 may be disposed of or used as animal feed.

An alternative to providing the storage container 46 in the milking installation 2 may be to connect the second milk receiver 26 to a drain.

The at least one robot arm 32 is configured to attach the teat cups 34 to the teats of animals presenting themself for milking in one of the milking positions 8. The at least one robot arm 32 may be associated with at least one milking position 8.

Accordingly, the milking installation 2 may comprise one individual robot arm 32 for at least some of the milking positions 8.

According to embodiments, the at least one robot arm 32 may be configured to attach the at least one teat cup 34 of two adjacent milking positions 8 to a teat of a respective animal. In this manner, no individual robot arm is required at each milking position 8. Accordingly, the milking installation 2 may be simplified since one robot arm 32 may be shared by two milking positions 8.

According to these embodiments, the milking installation 2 may comprise one or more robot arms 32 configured to attach the teat cups 34 to animals in more than one milking position 8.

Such a robot arm 32 may be configured to rotate and/or travel laterally in order to reach the different milking positions 8 to be served by the robot arm 32, as indicated in FIG. 2a by the arrows at the robot arm 32.

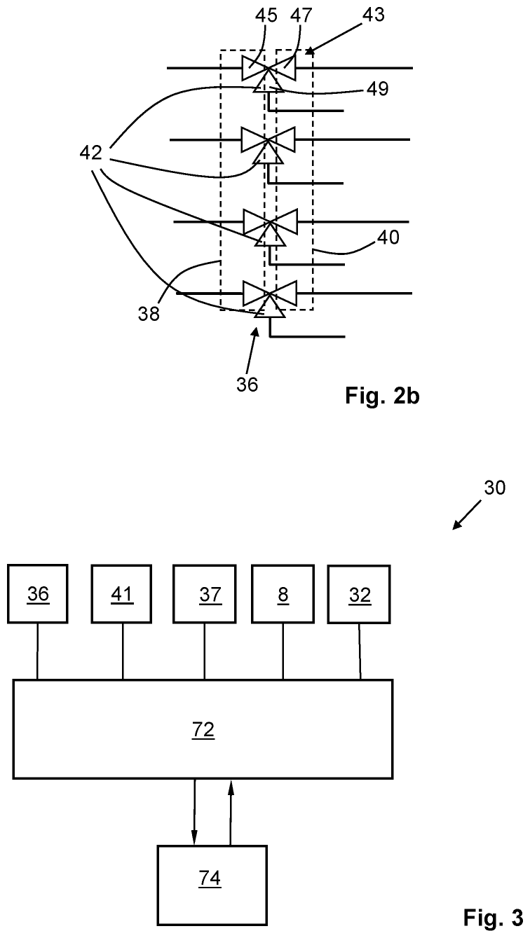

FIG. 3 illustrates a control arrangement 30 for controlling a milking installation. The milking installation may be a milking installation 2 as discussed above with reference to FIGS. 1-2b. Accordingly, in the following reference is also made to FIGS. 1-2b.

The control arrangement 30 comprises a calculation unit 72 which may take the form of substantially any suitable type of processor circuit or microcomputer, e.g. a circuit for digital signal processing (digital signal processor, DSP), a Central Processing Unit (CPU), a processing unit, a processing circuit, a processor, an Application Specific Integrated Circuit (ASIC), a microprocessor, or other processing logic that may interpret and execute instructions. The herein utilised expression calculation unit 72 may represent a processing circuitry comprising a plurality of processing circuits, such as, e.g., any, some or all of the ones mentioned above.

The control arrangement 30 may comprise a memory unit 74. The calculation unit 72 is connected to the memory unit 74, which provides the calculation unit 72 with, for example, stored programme code and/or stored data which the calculation unit 72 needs to enable it to do calculations. The calculation unit 72 may also be adapted to storing partial or final results of calculations in the memory unit 74.

A database over animals of a farm, such as animals 4 of groups 6 of animals to be milked in the milking installation 2 may be stored in the memory unit 74. The database may include animal related data on animal individual basis. The animal individual data may be updated by a farmer and/or by data established in the milking installation 2, such as data established by analysing milk, analysing blood samples, analysing animal breath, etc.

The memory unit 74 may comprise a physical device utilised to store data or programs i.e., sequences of instructions, on a temporary or permanent basis.

The calculation unit 72 is connected to various parts and/or components of the milking installation 2 to control their operation e.g., for controlling milking operations, for measuring and/or determining milking parameters and/or milk parameters, etc.

Exemplified in FIG. 3 are connections of the calculation unit 72 with one each of a milking position 8, a robot arm 32, an animal identification device 37, a milk sensor arrangement 41, and a flow directing arrangement 36. Naturally, the number of such connections may correspond the number of relevant devices in the milking installation 2.

The control arrangement 30 may comprise more than one calculation unit 72 and more than one memory unit 74. For instance, the control arrangement 30 may be a distributed control arrangement with two or more separate calculation units, each configured for one or more particular tasks within the milking installation 2, such as controlling opening and closing of entrance and exit gates of the milking positions 8, controlling milking operations, operating a robot arm 32, analysing milk, controlling the flow directing arrangement 36, etc, and/or each configured for controlling various devices at each milking position 8.

It is to be understood that the foregoing is illustrative of various example embodiments and that the invention is defined only by the appended claims. A person skilled in the art will realize that the example embodiments may be modified, and that different features of the example embodiments may be combined to create embodiments other than those described herein, without departing from the scope of the invention, as defined by the appended claims.

1. A milking installation (2) configured to milk animals (4), the milking installation (2) comprising a number of milking positions (8) configured to milk one of the animals (4) at a time, a first common milk line (20), a first milk receiver (22), a second common milk line (24), a second milk receiver (26), a vacuum system (28), a control arrangement (30), and at least one robot arm (32), wherein
each said milking position (8) of the number of milking positions (8) comprises at least one teat cup (34) and a flow directing arrangement (36), the flow directing arrangement (36) comprising an inlet arrangement (38), a first outlet arrangement (40), and a second outlet arrangement (42), wherein
the at least one teat cup (34) is connected to the inlet arrangement (38), the first outlet arrangement (40) is connected to the first common milk line (20), and the second outlet arrangement (42) is connected to the second common milk line (24), wherein
the control arrangement (30) is configured to control the flow directing arrangement (36) at each of the milking positions (8) to fluidly connect the at least one teat cup (34) via the inlet arrangement (38) with either the first outlet arrangement (40) or the second outlet arrangement (42), wherein
the first common milk line (20) is connected to the first milk receiver (22) and the second common milk line (24) is connected to the second milk receiver (26), wherein
the vacuum system (28) is connected to the first milk receiver (22) and to the second milk receiver (26), and wherein
the at least one robot arm (32) is configured to attach the at least one teat cup (34) of at least one of the milking positions (8) to a teat of one of the animals (4).

2. The milking installation (2) according to claim 1, wherein each of the milking positions (8) is configured to, during milking of an individual one of the animals (4), conduct milk from the one animal individual (4) via the flow directing arrangement (36), to the first milk receiver (22) or to the second milk receiver (26).

3. The milking installation (2) according to claim 1, wherein each of the milking positions (8) comprises a milk sensor arrangement (41) fluidly connected to the at least one teat cup (34), and wherein the control arrangement (30) is configured to control the flow directing arrangement (36) to fluidly connect the at least one teat cup (34) via the inlet arrangement (38) with either the first outlet arrangement (40) or the second outlet arrangement (42) based on animal individual (4) milk parameters sensed by the milk sensor arrangement (41).

4. The milking installation (2) according to claim 1, wherein each of the milking positions (8) comprises an animal identification device (37), and wherein the control arrangement (30) is configured to control the flow directing arrangement (36) to fluidly connect the at least one teat cup (34) via the inlet arrangement (38) with either the first outlet arrangement (40) or the second outlet arrangement (42) based on animal identity provided by the animal identification device (37).

5. The milking installation (2) according to claim 1, comprising a milk cooling tank (44), wherein the first milk receiver (22) is fluidly connected to the milk cooling tank (44).

6. The milking installation (2) according to claim 1, comprising a storage container (46), wherein the second milk receiver (26) is connected to the storage container (46).

7. The milking installation (2) according to claim 1, comprising a holding area (10) configured to temporarily house a group (6) of the animals (4) prior to being milked, wherein each said milking position (8) of the number of milking positions (8) is arranged with direct access from the holding area (10).

8. The milking installation (2) according to claim 7, wherein the holding area (10) is configured for the group of the animals (4) to move freely therein.

9. The milking installation (2) according to claim 1, wherein the at least one robot arm (32) is configured to attach the at least one teat cup (34) of two adjacent said milking positions (8) to a teat of a respective one of the animals (4).

10. The milking installation (2) according to claim 1, wherein each of the milking positions (8) comprises several of the teat cups (34) and each said teat cup (34) is connected to the inlet arrangement (38) of the flow directing arrangement (36) via a respective milk conduit (39).

11. The milking installation of claim 1, wherein each of the milking positions is configured to conduct the milk directly from the one animal individual via the flow directing arrangement to the first milk receiver or to the second milk receiver, so that the milk is directly conducted from a given said teat cup to one of the first and second milk receivers without temporarily storing the milk at the milking positions.

12. The milking installation according to claim 11, wherein each of the milking positions comprises a milk sensor arrangement fluidly connected to the at least one teat cup, and wherein the control arrangement is configured to control the flow directing arrangement to fluidly connect the at least one teat cup via the inlet arrangement with either the first outlet arrangement or the second outlet arrangement based on animal individual milk parameters sensed by the milk sensor arrangement.

13. The milking installation according to claim 12, wherein each of the milking positions comprises several of the teat cups and each of the teat cups is separately connected to the inlet arrangement of the flow directing arrangement via a respective milk conduit, and wherein the control arrangement is configured to separately control the flow directing arrangement for each of the teat cups to fluidly connect each of the teat cups separately via the inlet arrangement with either the first outlet arrangement or the second outlet arrangement, based on the individual milk parameters of the milk flowing from a given said teat cup.

14. The milking installation of claim 13, wherein the control arrangement is configured be able to put the flow directing arrangement in a shut off position, such that the at least one teat cup is fluidly connected via the inlet arrangement with neither the first outlet arrangement nor the second outlet arrangement.

15. A milking installation configured to milk animals, the milking installation comprising:
a plurality of milking positions configured to milk one of the animals at a time, each of the milking positions comprising:
a plurality of teat cups;
a plurality of milk conduits, each said milk conduit connected to a respective one of the teat cups, each of the milk conduits including a milk sensor configured to sense at least one milk parameter of the milk flowing through the milk conduit that can be used to determine whether the milk flowing through the conduit is suitable for human consumption; and
a plurality of valves, each of the valves having an inlet connected to a respective one of the milk conduits, each of the valves further comprising first and second outlets;
a first milk receiver connected by a first common milk line to each of the first outlets of the valves;
a second milk receiver connected by a second common milk line to each of the second outlets of the valves;
a vacuum system connected to the first and second milk receivers; and
a control arrangement connected to each of the milk sensors and to each of the valves,
wherein the control arrangement is configured to control whether the inlet of a given said valve is fluidly connected to the first outlet or the second outlet of the given valve based on whether the at least one parameter associated with the milk flowing to the given valve indicates that the milk is suitable for human consumption, such that the milk received in a given said teat cup is passed to the first milk receiver if said milk is suitable for human consumption, and the milk received in a given said teat cup is passed to the second milk receiver if said milk is not suitable for human consumption, and
wherein the milking installation is configured so that the milk is directly conducted from a given said teat cup to one of the first and second milk receivers, without temporarily storing milk at the milking positions.

16. The milking installation of claim 15, wherein the control arrangement is further configured to control whether a given said valve is placed in a shut off position, in which the inlet of the given valve is connected neither to the first outlet nor the second outlet of the given valve.
